(19) United States
(12) Patent Application Publication
(10) Pub. No.: US 2020/0117209 A1
(43) Pub. Date: Apr. 16, 2020

(54) SMALL SIZE VEHICLE

(71) Applicant: TOYOTA JIDOSHA KABUSHIKI KAISHA, Toyota-shi (JP)

(72) Inventors: Tae SUGIMURA, Miyoshi-shi (JP); Hirotaka KARUBE, Toyota-shi (JP); Kazuki MATSUMOTO, Ohgaki-shi (JP); Makoto MORI, Nagakute-shi (JP); Jun KONDO, Nissin-shi (JP)

(73) Assignee: TOYOTA JIDOSHA KABUSHIKI KAISHA, Toyota-shi (JP)

(21) Appl. No.: 16/513,918

(22) Filed: Jul. 17, 2019

(30) Foreign Application Priority Data
Oct. 11, 2018 (JP) 2018-192264

(51) Int. Cl. G05D 1/02; G06K 9/00; G05D 1/00; G01C 21/34

(52) U.S. Cl. CPC G05D 1/0246; G01C 21/3453; G05D 1/0088; G06K 9/00805

(57) ABSTRACT

A small size vehicle includes an imaging unit configured to capture an image of a space ahead of the small size vehicle, a receiver configured to receive an emergency signal, an acquisition unit configured to acquire pre-set evacuation route information in a case where the emergency signal is received, and a determination unit configured to determine whether an evacuation route indicated by the evacuation route information is passable for a person or not based on the image captured by the imaging unit, when the small size vehicle travels along the evacuation route.

### INCORPORATION BY REFERENCE

The disclosure of Japanese Patent Application No. 2018-192264 filed on Oct. 11, 2018 including the specification, drawings and abstract is incorporated herein by reference in its entirety.

### BACKGROUND

### 1. Technical Field

The disclosure relates to a small size vehicle.

### 2. Description of Related Art

There is a system that converts disaster information into an expression format compatible with VICS (registered trademark) and distributes distribution information, which is generated when the converted disaster information is superimposed on road traffic information, to a vehicle (for example, refer to Japanese Unexamined Patent Application Publication No. 2007-087287 (JP 2007-087287 A)). In addition, there is an image processing device that changes an operation mode when acquiring information related to a disaster (for example, refer to Japanese Patent No. 4687618 (JP 4687618 B)).

### SUMMARY

Disaster victims are supposed to go to a safe evacuation site through a predetermined evacuation route when a disaster occurs. However, the disaster victims cannot determine whether the evacuation route is actually passable or not even if disaster information is received and an operation mode of a predetermined device is switched.

The disclosure provides a small size vehicle that is able to determine whether an evacuation route for disaster victims is passable or not.

An aspect of the disclosure relates to a small size vehicle including an imaging unit, a receiver, an acquisition unit, and a determination unit. The imaging unit is configured to capture an image of a space ahead of the small size vehicle. The receiver is configured to receive an emergency signal. The acquisition unit is configured to acquire pre-set evacuation route information in a case where the emergency signal is received. The determination unit is configured to determine whether an evacuation route indicated by the evacuation route information is passable for a person or not, based on the image captured by the imaging unit, when the small size vehicle travels along the evacuation route.

The small size vehicle according to the aspect of the disclosure may further include a driving controller configured to control autonomous travel. The driving controller may perform control such that the small size vehicle autonomously travels along the evacuation route in a case where the emergency signal is received.

In the small size vehicle according to the aspect of the disclosure, the driving controller may perform control such that the small size vehicle autonomously travels to a pre-set point in a case where the small size vehicle reaches an end point of the evacuation route.

The small size vehicle according to the aspect of the disclosure may further include an output unit configured to output result information indicating whether the evacuation route is passable for a person up to an end point or not.

In the small size vehicle according to the aspect of the disclosure, the determination unit may determine whether an obstacle is present on the evacuation route or not, based on the image captured by the imaging unit and determine whether the evacuation route is passable for a person or not in accordance with presence or absence of the obstacle.

The small size vehicle according to the aspect of the disclosure may further include a removing member and a drive controller. The removing member is configured to remove an obstacle. The drive controller is configured to control driving of the removing member to move a removable obstacle outside the evacuation route in a case where the determination unit determines that the removable obstacle is present on the evacuation route.

In the small size vehicle according to the aspect of the disclosure, in a case where the determination unit determines that an obstacle on the evacuation route is not removable, the determination unit may register a point on which the obstacle is present as a point not passable for a person.

According to the aspect of the disclosure, it is possible to determine whether an evacuation route for disaster victims is passable or not.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram illustrating a schematic configuration of a route determination system according to an embodiment;

FIG. 2 is a diagram illustrating an example of a hardware configuration of an information processing device according to the embodiment;

FIG. 3 is a perspective view illustrating a schematic configuration of an inverted type mobile object according to the embodiment;

FIG. 4 is a block diagram illustrating a schematic system configuration of the inverted type mobile object according to the embodiment;

FIG. 5 is a view illustrating a schematic configuration of a personal type mobile object according to the embodiment;

FIG. 6 is a block diagram illustrating a schematic system configuration of the personal type mobile object according to the embodiment;

FIG. 7 is a block diagram illustrating a functional configuration of a small size vehicle according to the embodiment;

FIG. 8 is a flowchart illustrating an example of a passability determination process according to the embodiment;

FIG. 9 is a diagram illustrating an evacuation route at the time of a disaster;

FIG. 10 is a diagram illustrating an example in which the small size vehicle is positioned ahead of an obstacle;

FIG. 11 is a diagram for describing removal of the obstacle which is performed by the small size vehicle;

FIG. 12 is a diagram illustrating a state where the small size vehicle reaches an end point of the evacuation route;

FIG. 13 is a diagram illustrating a state where the small size vehicle returns to a start point of the evacuation route;

FIG. 14A is a diagram illustrating an example of notification about result information of passability determination; and

FIG. 14B is a diagram illustrating another example of the notification about the result information of the passability determination.

### DETAILED DESCRIPTION OF EMBODIMENTS

Hereinafter, an embodiment will be described in detail with reference to drawings. Note that, the same elements will be given the same reference numerals and repetitive description will be omitted.

According to the present embodiment, at the time of a disaster, small size vehicles determine whether a pre-set evacuation route is passable for a person or not when traveling along the evacuation route and thus determination on whether the evacuation route is passable or not can be made in advance, the small size vehicles including an inverted type mobile object which travels on a road or a personal type mobile object for one person or two persons.

Configuration of System

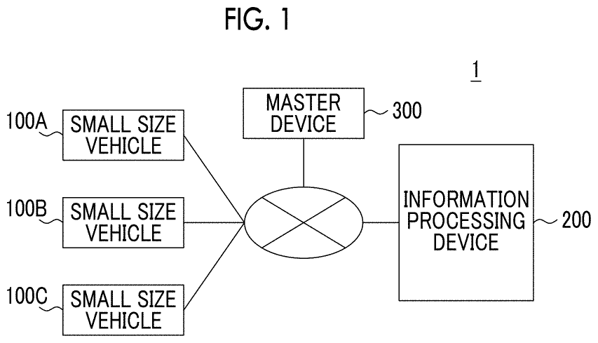

FIG. 1 is a diagram illustrating a schematic configuration of a route determination system 1 according to the present embodiment. As shown in FIG. 1, the route determination system 1 includes a small size vehicle 100A, a small size vehicle 100B, a small size vehicle 100C, an information processing device 200, and a master device 300. In addition, all or a portion of the above-described devices are connected to each other via a communication network such that communication therebetween can be performed. The communication network may be any of the Internet, a local area network (LAN), a mobile communication network, Bluetooth (registered trademark), Wireless Fidelity (WiFi), another communication line, a combination thereof, or the like. Note that, the number of small size vehicles (for example, personal mobility vehicles) and the number of information processing devices (for example, servers) are not limited to those in the above-described example as long as an appropriate number of small size vehicles and an appropriate number of information processing devices are provided in accordance with the size of the system. Hereinafter, the small size vehicles 100A, 100B, 100C will be simply referred to as “small size vehicles 100” when the small size vehicles 100A, 100B, 100C are collectively referred without being distinguished from each other.

The master device 300 is a device that transmits an emergency signal generated at the time of a disaster. For example, the master device 300 predicts whether an earthquake or a seismic sea wave will occur or not based on information acquired from a sensor such as a seismometer and generates the emergency signal in a case where the master device 300 predicts that there will be significant damage.

Hardware Configuration of Information Processing Device

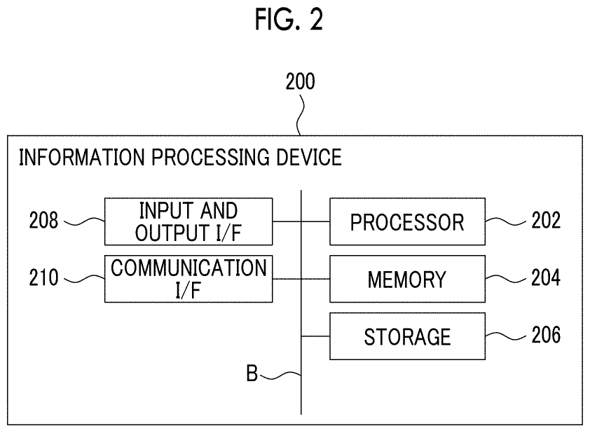

FIG. 2 is a diagram illustrating an example of a hardware configuration of the information processing device 200 according to the present embodiment. As shown in FIG. 2, the information processing device 200 includes a processor 202, a memory 204, a storage 206, an input and output interface (input and output I/F) 208, and a communication interface (communication I/F) 210. The components of the hardware (HW) of the information processing device 200 are connected to each other via, for example, a bus B.

The information processing device 200 realizes at least one of a function or a method described in the present embodiment by the cooperation among the processor 202, the memory 204, the storage 206, the input and output I/F 208, and the communication I/F 210.

The processor 202 performs at least one of a function or a method realized by a code or a command included in a program stored in the storage 206. Examples of the processor 202 include a central processing unit (CPU), a micro processing unit (MPU), a graphics processing unit (GPU), a microprocessor, a processor core, a multiprocessor, an application-specific integrated circuit (ASIC), a field programmable gate array (FPGA), or the like.

The memory 204 temporarily stores the program loaded from the storage 206 and provides a work area for the processor 202. Various kinds of data that are generated while the processor 202 is executing the program are also temporarily stored in the memory 204. Examples of the memory 204 include a random access memory (RAM), a read only memory (ROM), or the like.

The storage 206 stores the program executed by the processor 202 or the like. Examples of the storage 206 include a hard disk drive (HDD), a solid state drive (SSD), a flash memory, or the like.

The input and output I/F 208 includes an input device used to input various operations with respect to the information processing device 200 and an output device that outputs the result of a process performed by the information processing device 200. The input and output I/F 208 also outputs the result of the process to a display device or a speaker.

The communication I/F 210 receives and transmits various kinds of data via a network. The communication may be performed in any of a wired manner and a wireless manner and any communication protocol may be used as long as the communication can be performed. The communication I/F 210 has a function of communicating with the small size vehicle 100 via the network. The communication I/F 210 transmits various kinds of data to another information processing device or the small size vehicle 100 in accordance with an instruction from the processor 202. Note that, a hardware configuration of the master device 300 is the same as the hardware configuration of the information processing device 200.

The program in the present embodiment may be provided in a state of being stored in a computer-readable storage medium. The storage medium can store the program in a “non-temporary tangible medium”. The program includes, for example, a software program or a computer program.

At least a portion of the process in the information processing device 200 may be realized by means of cloud computing established by one or more computers. A configuration in which at least a portion of the process in the information processing device 200 is performed by another information processing device may also be adopted. In this case, a configuration in which at least a portion of a process of each functional unit realized by the processor 202 is performed by another information processing device may also be adopted.

Configuration of Inverted Type Mobile Object

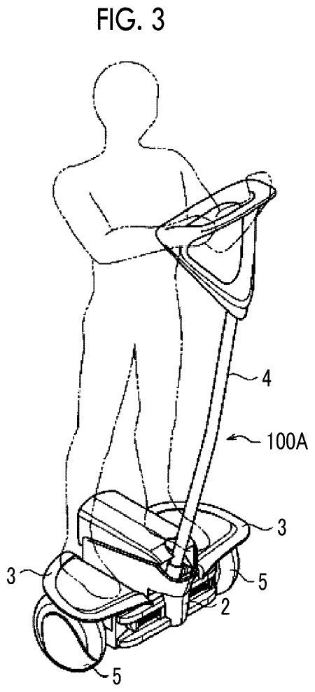

FIG. 3 is a perspective view illustrating a schematic configuration of an inverted type mobile object according to the present embodiment. An inverted type mobile object 100A according to the embodiment is provided with, for example, a vehicle main body 2, a pair of right and left step portions 3 that is attached to the vehicle main body 2 and that an occupant steps on, an operation handle 4 that is tiltably attached to the vehicle main body 2 and that the occupant holds, and a pair of right and left drive wheels 5 that is rotatably attached to the vehicle main body 2.

The inverted type mobile object 100A according to the present embodiment is configured as a coaxial two-wheel vehicle of which the drive wheels 5 are disposed to be coaxial with each other and which travels while maintaining an inverted state, for example. The inverted type mobile object 100A is configured to move forward and backward when the centroid of the occupant is moved forward and backward such that the step portions 3 of the vehicle main body 2 are inclined forward and backward and is configured to turn right and left when the centroid of the occupant is moved rightward and leftward such that the step portions 3 of the vehicle main body 2 are inclined rightward and leftward. Note that, as the inverted type mobile object 100A, the coaxial two-wheel vehicle as described above is applied. However, the disclosure is not limited thereto and can be applied to any mobile object that travels while maintaining an inverted state.

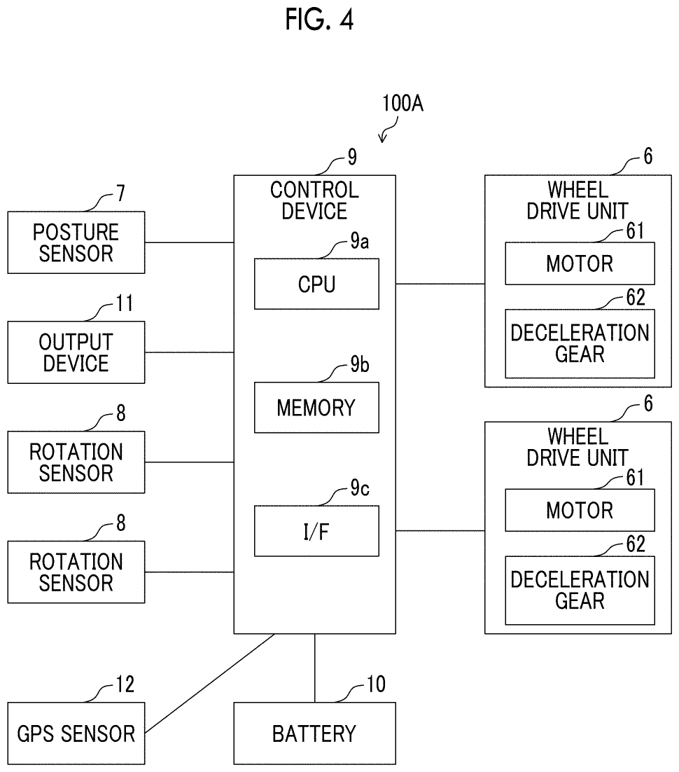

FIG. 4 is a block diagram illustrating a schematic system configuration of the inverted type mobile object according to the present embodiment. The inverted type mobile object 100A according to the present embodiment is provided with a pair of wheel drive units 6 that drives the drive wheels 5, a posture sensor 7 that detects the posture of the vehicle main body 2, a pair of rotation sensors 8 that detects rotation information of the drive wheels 5, a control device 9 that controls the wheel drive units 6, a battery 10 that supplies electrical power to the wheel drive units 6 and the control device 9, an output device 11 that can output a sound or a display screen, a global positioning system (GPS) sensor 12 that senses position information.

The wheel drive units 6 are built into the vehicle main body 2 and drive the right and left drive wheels 5, respectively. The wheel drive units 6 can drive the drive wheels 5 to rotate independently of each other. Each of the wheel drive units 6 can be configured to include a motor 61 and a deceleration gear 62 that is coupled to a rotation shaft of the motor 61 such that a motive power can be transmitted.

The posture sensor 7 is provided in the vehicle main body 2 and detects and outputs posture information of the vehicle main body 2, the operation handle 4, or the like. The posture sensor 7 detects the posture information at the time of the traveling of the inverted type mobile object 100A and is configured to include a gyro sensor, an acceleration sensor, or the like. When the occupant inclines the operation handle 4 forward or backward, the step portions 3 are inclined in the same direction as the operation handle 4 and the posture sensor 7 detects posture information corresponding to the inclination. The posture sensor 7 outputs the detected posture information to the control device 9.

The rotation sensors 8 are provided in the drive wheels 5 respectively and can detect rotation information such as the rotation angles, the rotary angular velocities, and the rotary angular accelerations of the drive wheels 5. Each of the rotation sensors 8 is configured to include, for example, a rotary encoder, a resolver, and the like. The rotation sensors 8 output the detected rotation information to the control device 9.

The battery 10 is built into the vehicle main body 2 and is a lithium ion battery, for example. The battery 10 supplies electrical power to the wheel drive units 6, the control device 9, and other electronic devices.

The control device 9 generates and outputs a control signal for driving and controlling the wheel drive units 6 based on detection values output from the various sensors built into the inverted type mobile object. For example, the control device 9 performs a predetermined calculation process based on the posture information output from the posture sensor 7, the rotation information of the drive wheels 5 output from the rotation sensors 8 and outputs the control signals to the wheel drive units 6 as needed. The control device 9 controls the wheel drive units 6 to perform inversion control such that the inverted state of the inverted type mobile object 100A is maintained.

In order to realize the above-described process, the control device 9 includes a CPU 9a, a memory 9b, and an I/F 9c. The CPU 9a performs at least one of a function or a method realized by a code or a command included in a program stored in the memory 9b.

The memory 9b stores the program and provides a work area for the CPU 9a. Various kinds of data that are generated while the CPU 9a is executing the program are also temporarily stored in the memory 9b. Examples of the memory 9b include a random access memory (RAM), a read only memory (ROM), or the like.

The I/F 9c includes an input device used to input various operations with respect to the control device 9 and an output device that outputs the result of a process performed by the control device 9.

The output device 11 is a specific example of notification means. The output device 11 displays the result of evacuation route determination to the occupant or notifies the occupant of the result of the evacuation route determination by using a voice or the like in accordance with a control signal from the control device 9. The output device 11 is configured to include a speaker which outputs a sound, a display (display device), or the like.

The GPS sensor 12 acquires current position information of the inverted type mobile object 100A. The GPS sensor 12 is, for example, a part of a position information measuring system in which artificial satellites are used and precisely measures the position (latitude, longitude, and altitude) of the inverted type mobile object from any point on the earth by receiving radio waves from a plurality of GPS satellites. Note that, the inverted type mobile object 100A may be provided with an imaging device or a communication device.

Configuration of Personal Type Mobile Object

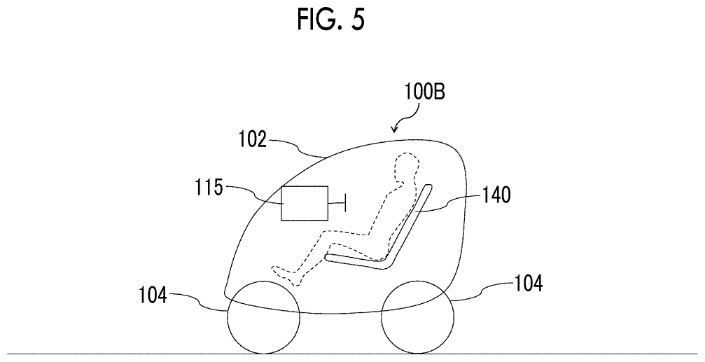

FIG. 5 is a view illustrating a schematic configuration of a personal type mobile object according to the present embodiment. A personal type mobile object 100B according to the present embodiment is provided with, for example, a vehicle main body 102, a seat unit 140 that is attached to the vehicle main body 102 and that an occupant (drivers) sits on, an operation unit 115 that the occupant holds and with which the occupant can drive the personal type mobile object 100B, and a pair of right and left drive wheels 104 that is rotatably attached to the vehicle main body 102.

The personal type mobile object 100B according to the present embodiment is, for example, a small size vehicle with a seat for one person or two persons and a configuration in which two drive wheels 104 are provided on a front side and one drive wheel 104 is provided on a rear side may also be adopted. Movement of the personal type mobile object 100B may be controlled by a driver operating the personal type mobile object 100B and the personal type mobile object 100B may enter an autonomous travel mode such that autonomous travel thereof is controlled based on images captured by an imaging device 170 or a plurality of sensors.

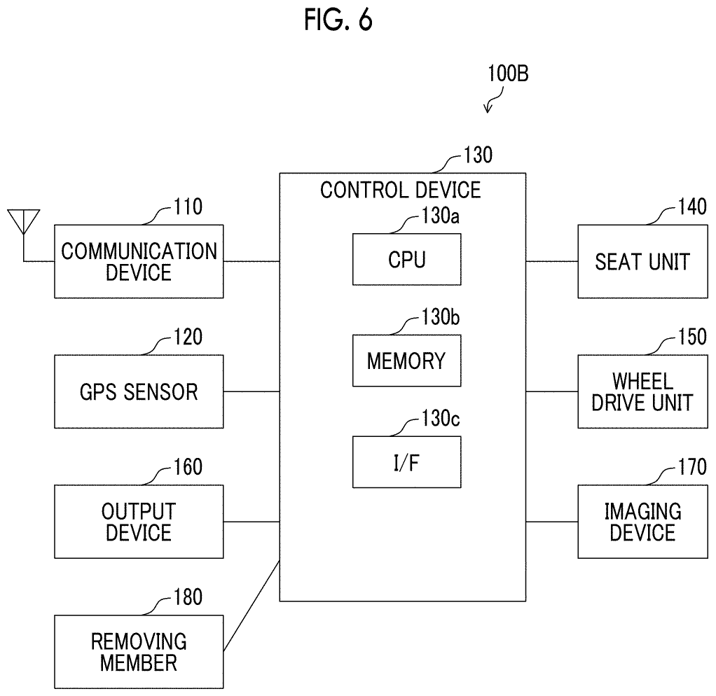

FIG. 6 is a block diagram illustrating a schematic system configuration of the personal type mobile object according to the present embodiment. The personal type mobile object 100B according to the present embodiment is provided with a pair of wheel drive units 150 that drives the drive wheels 104, the seat unit 140 that the occupant can sit on, a communication device 110 that can communicate with an external device, the operation unit 115 with which the occupant can perform a driving operation, a GPS sensor 120 that acquires position information, an output device 160 that can output sound data or display data, the imaging device 170 that captures an image, and a removing member 180 for removing an obstacle.

The GPS sensor 120 acquires current position information of the personal type mobile object 100B. The GPS sensor 120 is, for example, a part of a position information measuring system in which artificial satellites are used and precisely measures the position (latitude, longitude, and altitude) of the personal type mobile object from any point on the earth by receiving radio waves from a plurality of GPS satellites.

A control device 130 generates and outputs a control signal for driving and controlling the wheel drive units 150 based on detection values of various sensors installed in the personal type mobile object 100B and the contents of an operation performed by the occupant using the operation unit 115.

In order to realize various processes, the control device 130 includes a CPU 130a, a memory 130b, and an I/F 130c. The CPU 130a performs at least one of a function or a method realized by a code or a command included in a program stored in the memory 130b.

The memory 130b stores the program and provides a work area for the CPU 130a. Various kinds of data that are generated while the CPU 130a is executing the program are also temporarily stored in the memory 130b. Examples of the memory 130b include a random access memory (RAM), a read only memory (ROM), or the like.

The I/F 130c includes an input device used to input various operations with respect to the control device 130 and an output device that outputs the result of a process performed by the control device 130.

The seat unit 140 is a seat unit that the occupant sits on and may be configured to be able to be reclined.

The wheel drive units 150 are built into the vehicle main body 102 and drive the pair of right and left drive wheels 104 and the one drive wheel 104 on the rear side, respectively.

The output device 160 is a specific example of notification means. The output device 160 notifies the occupant or a person on the outside of the vehicle about the result of determination on whether an evacuation route is passable or not in accordance with a control signal from the control device 130. The output device 160 may be configured to include a speaker which outputs a sound, a display device which displays a display screen, or the like.

The imaging device 170 is provided at a position such that the imaging device 170 captures an image of a space ahead of the personal type mobile object 100B. The imaging device 170 outputs the captured image, which is obtained by capturing the image of the space ahead of the personal type mobile object 100B, to the control device 130.

The removing member 180 is a member for removing an obstacle (for example, trash, box, corrugated board, or like) on a road. The removing member 180 is provided in a front portion of the personal type mobile object 100B. The removing member 180 is usually accommodated in the front portion and when the removing member 180 is driven by a drive controller which will be described later, the removing member 180 is controlled such that the removing member 180 is extracted from the front portion to the outside of the vehicle and performs a predetermined operation of pivoting, rotating, moving forward, or the like. When the removing member 180 performs the predetermined operation, a predetermined obstacle is removed from a route. The predetermined obstacle is determined from the image captured by the imaging device 170 and a possibility that the predetermined obstacle can be removed or not may be determined based on the size of the obstacle or by means of object recognition with respect to the obstacle, or the like.

Hereinafter, the inverted type mobile object 100A and the personal type mobile object 100B are collectively referred to as small size vehicles or personal mobility vehicles and description on the small size vehicle will be made while using the personal type mobile object 100B while the inverted type mobile object 100A may also be used.

Functional Configuration

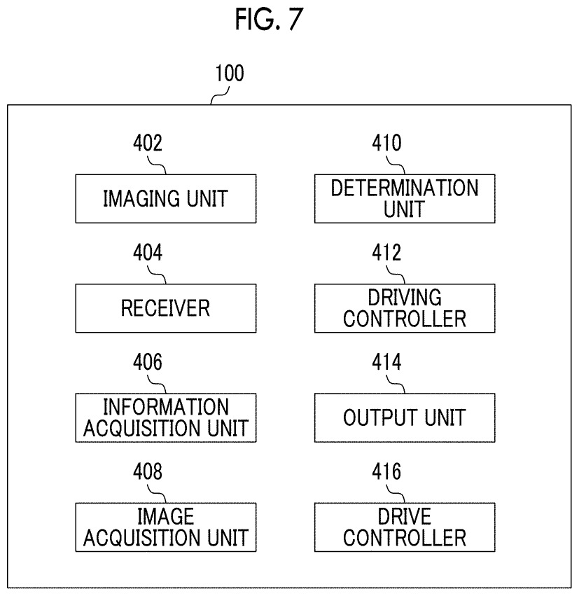

FIG. 7 is a block diagram illustrating a functional configuration of the small size vehicle 100 according to the present embodiment. The small size vehicle 100 shown in FIG. 7 includes an imaging unit 402, a receiver 404, an information acquisition unit 406, an image acquisition unit 408, a determination unit 410, a driving controller 412, an output unit 414, and a drive controller 416.

The imaging unit 402 shown in FIG. 7 may be realized by, for example, the imaging device 170 shown in FIG. 6. The receiver 404 may be realized by, for example, the communication device 110 shown in FIG. 6. The information acquisition unit 406, the image acquisition unit 408, the determination unit 410, the driving controller 412, and the drive controller 416 may be realized by, for example, the control device 130 shown in FIG. 6. The output unit 414 may be realized by, for example, the output device 160 shown in FIG. 6.

The imaging unit 402 periodically captures an image of a space ahead of the small size vehicle. For example, the imaging unit 402 is provided at a position such that a road ahead of the small size vehicle is in an imaging range of the imaging unit 402. The imaging unit 402 outputs the captured image to the image acquisition unit 408. The meaning of “periodically” may be “at intervals of several milliseconds in real time” or “at intervals of several seconds” as long as an interval at which the imaging unit 402 captures an image of a space ahead of the small size vehicle may be appropriately set.

The receiver 404 receives the emergency signal transmitted from the master device 300. The emergency signal is, for example, an emergency earthquake prompt report, a typhoon prompt report, a heavy rainfall prompt report, or the like. The master device 300 can predict whether an earthquake or a seismic sea wave will occur or not based on information acquired from a sensor such as a seismometer and generate the emergency signal in a case where the master device 300 predicts that there will be significant damage. Emergency situation prediction may be performed by another device and an operator may manually make an instruction about occurrence of an emergency situation. In addition, the emergency signal includes area information for specifying a disaster area.

In a case where the receiver 404 receives the emergency signal, the information acquisition unit 406 acquires pre-set evacuation route information. The evacuation route information may be stored in the memory 130b such that the evacuation route information is acquired from the memory 130b and the evacuation route information may be stored in the storage 206 or the memory 204 of the information processing device 200 such that the evacuation route information is acquired by being received from the information processing device 200. The acquired evacuation route information is output to the determination unit 410.

The image acquisition unit 408 sequentially acquires captured images from the imaging unit 402. The acquired images are sequentially output to the determination unit 410. Note that, the images captured by the imaging unit 402 may be directly acquired by the determination unit 410.

When the small size vehicle 100 travels along an evacuation route indicated by the evacuation route information acquired by the information acquisition unit 406, the determination unit 410 determines whether the evacuation route is passable for a person or not based on the images captured by the imaging unit 402. For example, the determination unit 410 determines whether an obstacle through which the small size vehicle 100 cannot pass is present on the evacuation route or not. Examples of the obstacle through which the small size vehicle 100 cannot pass include a tree lying across a road, fallen rock or gravel blocking a road, a depressed road, a submerged road, a collapsed bridge, or the like.

For example, the determination unit 410 detects a road from a captured image and determines whether an obstacle is present on the detected road by using an object detection technology. The determination unit 410 learns about the features of an object in advance such that the determination unit 410 can detect the object on a road. Accordingly, at the time of a disaster, the small size vehicle 100 can determine whether a pre-set evacuation route is passable for a person or not traveling along the evacuation route. For example, when determination on an evacuation route is made before disaster victims evacuate, the disaster victims can know whether the evacuation route is passable or not in advance.

The determination unit 410 may determine whether the small size vehicle 100 is traveling along an evacuation route or not based on the captured images, the evacuation route information, and the position information from the GPS sensor 120.

In addition, the small size vehicle 100 may travel along an evacuation route by being driven by the occupant based on the evacuation route information and the small size vehicle 100 may autonomously travel along the evacuation route. In order to make the autonomous travel possible, the small size vehicle 100 includes the driving controller 412.

The driving controller 412 controls the autonomous travel of the small size vehicle 100. For example, the driving controller 412 has a function of performing control such that the small size vehicle 100 heads for a set destination while following a route based on an image and position information acquired from various sensors such as a 3D scanner (not shown), the imaging device 170, and the GPS sensor 120 and while avoiding obstacles.

In a case where the receiver 404 receives the emergency signal, the driving controller 412 performs control such that the small size vehicle 100 autonomously travels along an evacuation route based on the evacuation route information acquired from the information acquisition unit 406. Accordingly, even in a case where there is no occupant, determination on whether an evacuation route is passable or not can be made by means of the autonomous travel.

In a case where an end point on the evacuation route is reached, the driving controller 412 performs control such that the small size vehicle 100 autonomously travels to a pre-set point. Examples of the pre-set point include the start point of the evacuation route, a public space near the evacuation route, a school, and a shopping mall. Accordingly, when the small size vehicle 100 is at the pre-set point, the small size vehicle 100 can notify disaster victims that the evacuation route is passable.

The output unit 414 outputs result information that indicates whether an evacuation route is passable for a person up to an end point or not. In a case where the output unit 414 is a display device, the output unit 414 displays the result information on a display screen and in a case where the output unit 414 is a speaker, the output unit 414 outputs the result information by means of a voice or the like. In addition, in a case where the small size vehicle 100 includes both of a display device and a speaker, the output unit 414 may notify the disaster victims of the result information by using both of the display device and the speaker. Accordingly, the disaster victims can know whether the evacuation route is passable or not based on the result information from the small size vehicle 100.

In a case where the determination unit 410 determines that a removable obstacle is present on an evacuation route, the drive controller 416 controls the driving of the removing member 180 to move the obstacle outside the evacuation route. For example, in a case where the determination unit 410 determines that a removable obstacle such as a box or debris is present on an evacuation route, the drive controller 416 controls the removing member 180 such that the removing member 180 performs the predetermined operation. The predetermined operation is an operation of pivoting, rotating, or moving forward. Accordingly, even when an obstacle is on an evacuation route, it is possible to remove the obstacle by using the removing member 180 of the small size vehicle 100 in a case where the obstacle is removable.

Passability Determination Process

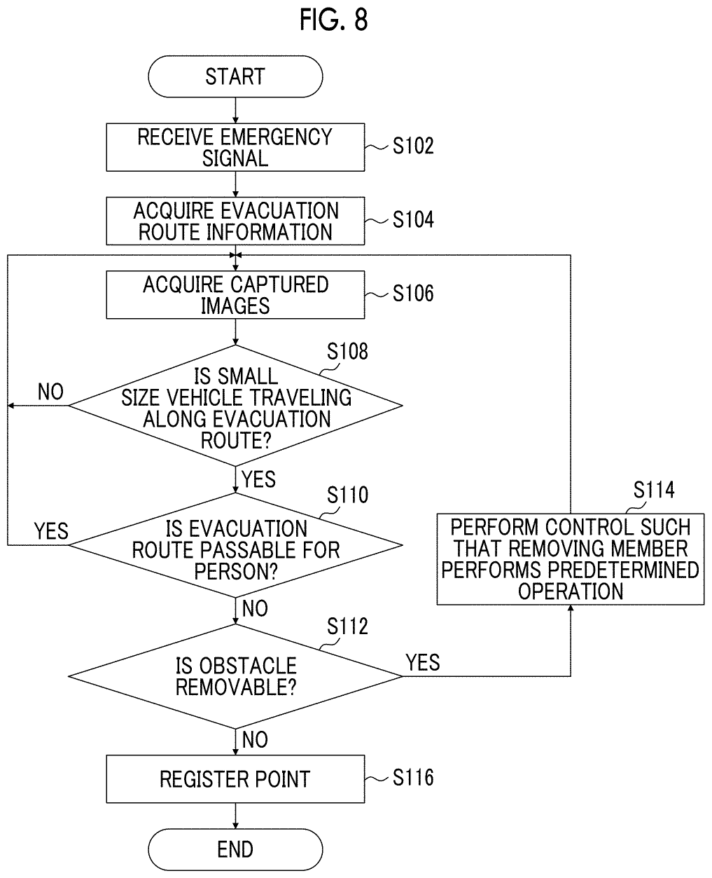

Next, a passability determination operation of the small size vehicle according to the present embodiment will be described. FIG. 8 is a flowchart illustrating an example of a passability determination process according to the present embodiment. In the example shown in FIG. 8, the receiver 404 receives the emergency signal transmitted from the master device 300 in step S102, for example.

In Step S104, the information acquisition unit 406 acquires the evacuation route information from the memory of the information acquisition unit 406 or from the information processing device 200.

In Step S106, the image acquisition unit 408 sequentially acquires the captured images from the imaging device 170.

In Step S108, the determination unit 410 determines whether the small size vehicle 100 is traveling along an evacuation route based on the captured images, the evacuation route information, and the position information from the GPS sensor 120. In a case where the small size vehicle 100 is traveling along the evacuation route, the process proceeds to Step S110 and in a case where the small size vehicle 100 is not traveling along the evacuation route, the process returns to Step S106.

In Step S110, the determination unit 410 determines whether the evacuation route is passable for a person or not based on the images captured by the imaging device 170. In a case where the evacuation route is passable for a person, the process returns to Step S106 and in a case where the evacuation route is not passable for a person, the process proceeds to Step S112.

In Step S112, the determination unit 410 determines whether an obstacle on the evacuation route is removable or not. In a case where the obstacle is removable, the process proceeds to Step S114 and in a case where the obstacle is not removable, the process proceeds to Step S116.

In Step S114, the drive controller 416 performs control such that the removing member 180 performs the predetermined operation. Due to the predetermined operation, the obstacle is positioned outside the evacuation route. Note that, the drive controller 416 may prepare a plurality of patterns as the predetermined operation and may change the patterns or combine the patterns to each other in accordance with the obstacle.

In a case where the determination unit 410 determines that the obstacle on the evacuation route is not removable, the determination unit 410 registers a point on which the obstacle is present in the evacuation route information (in Step S116). In addition, the determination unit 410 may transmit the position information acquired from the GPS sensor 120 and information indicating that the evacuation route is not passable to the information processing device 200 together with each other. Accordingly, it is possible to hold the information indicating that the evacuation route is not passable in association with the position information in order to notify the disaster victims that the evacuation route is not passable.

### Specific Example

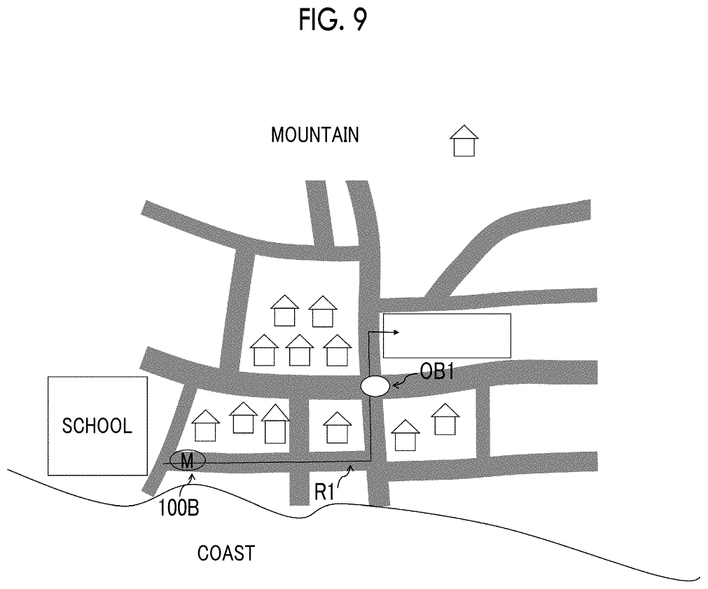

Next, a specific example of the passability determination process of the evacuation route according to the present embodiment will be described by using FIGS. 9 to 13. FIG. 9 is a diagram illustrating an evacuation route at the time of a disaster. In an example shown in FIG. 9, a route R1 is an evacuation route from a school to an open square. The evacuation route R1 may be set for each of predetermined points and each evacuation route may be held by the information processing device 200.

In the example shown in FIG. 9, the small size vehicle 100B is positioned near the school which is the start point of the evacuation route R1. In addition, an obstacle OB1 is present on the evacuation route R1. In addition, the small size vehicle 100B may travel along the evacuation route R1 by being driven by an occupant or the driving controller 412 may cause the small size vehicle 100B to autonomously travel along the evacuation route R1.

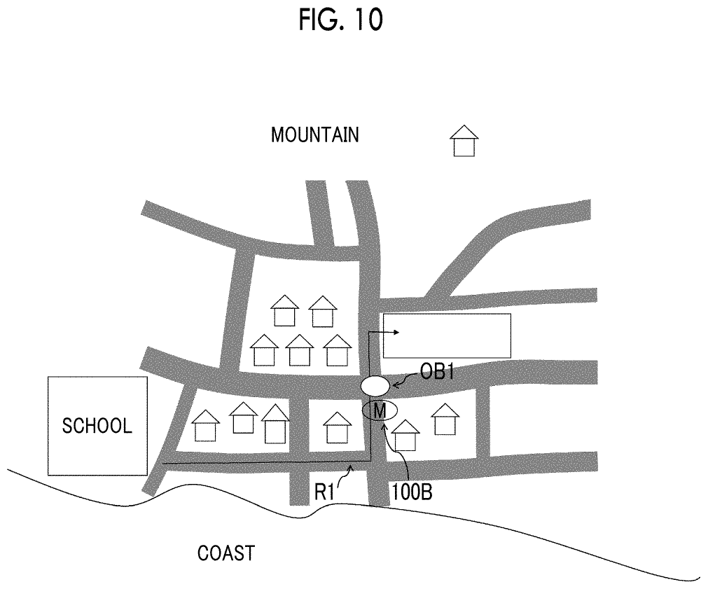

FIG. 10 is a diagram illustrating an example in which the small size vehicle 100B is positioned ahead of the obstacle OB1. In the example shown in FIG. 10, the determination unit 410 of the small size vehicle 100B determines that the obstacle OB1 is present on the evacuation route but the obstacle OB1 is removable. For example, the obstacle OB1 is an obstacle determined as trash or debris through image recognition.

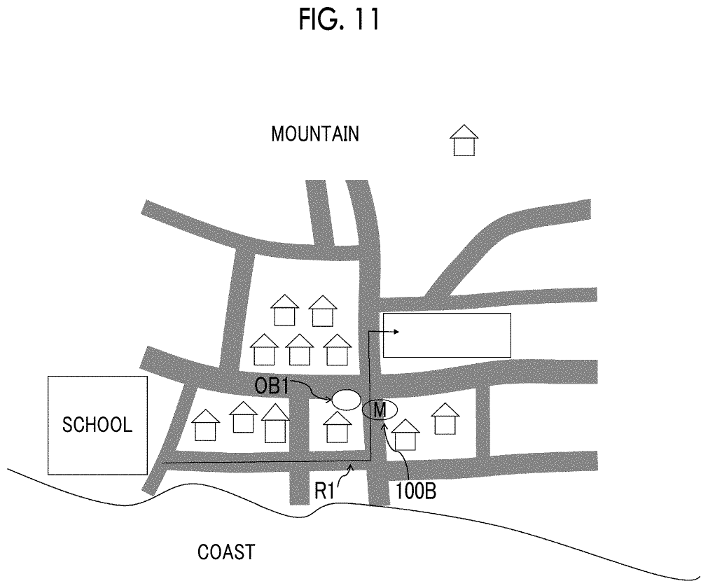

FIG. 11 is a diagram for describing removal of the obstacle OB1 which is performed by the small size vehicle 100B. In an example shown in FIG. 11, the small size vehicle 100B removes the obstacle OB1 to a side of the evacuation route R1 by using the removing member 180.

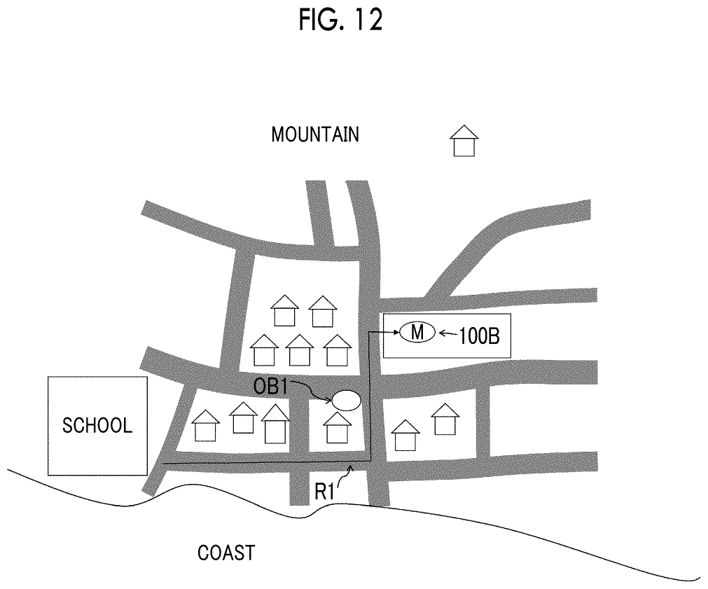

FIG. 12 is a diagram illustrating a state where the small size vehicle 100B reaches an end point of the evacuation route R1. In an example shown in FIG. 12, the small size vehicle 100B reaches the end point of the evacuation route R1 since the small size vehicle 100B can continue to travel along the evacuation route R1 when the obstacle OB1 is removed to a side of the evacuation route R1 by means of the removing member 180.

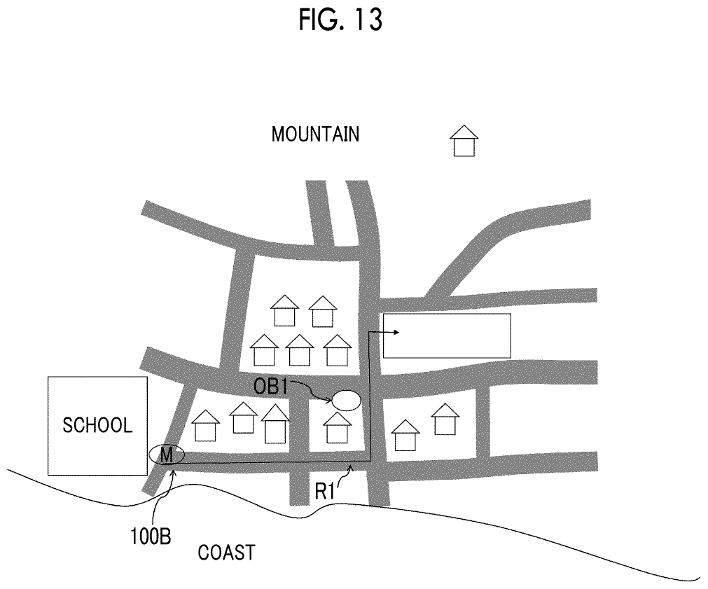

FIG. 13 is a diagram illustrating a state where the small size vehicle 100B returns to the start point of the evacuation route R1. FIG. 13 illustrates an example where the small size vehicle 100B returns to the start point of the evacuation route R1 after reaching the end point of the evacuation route R1. The small size vehicle 100B may perform notification about the result of determination on whether the evacuation route R1 is passable or not.

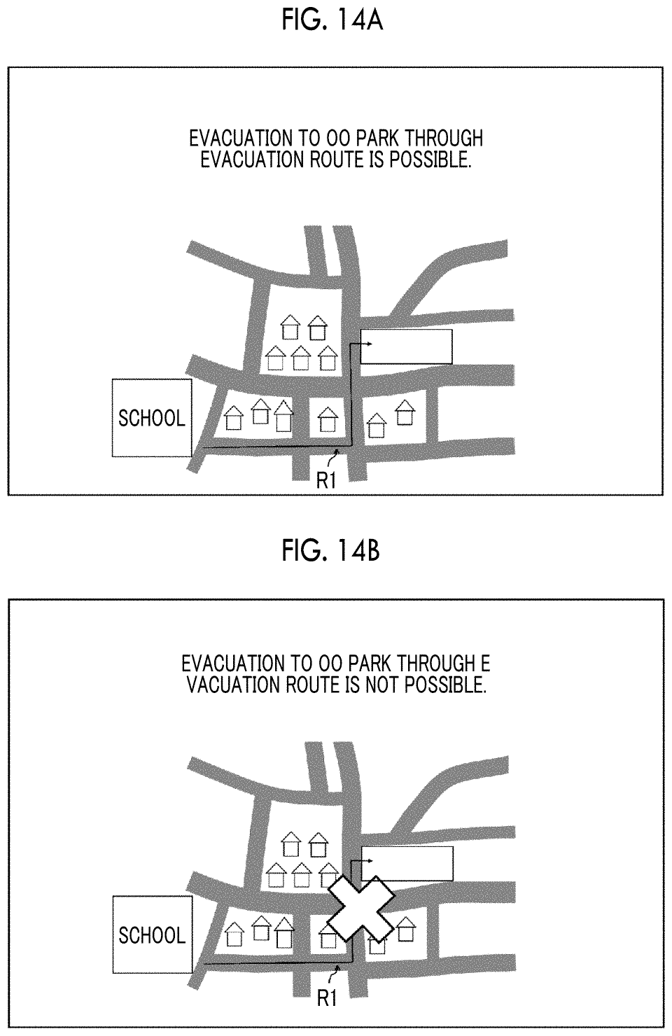

FIG. 14A is a diagram illustrating an example of notification about result information of passability determination. FIG. 14A illustrates an example where the evacuation route is passable. At this time, the output unit 414 may output a message indicating that the evacuation route is passable and the route, along which the small size vehicle 100B has traveled, together with each other. Accordingly, the disaster victims can know that the evacuation route is passable before evacuation.

FIG. 14B is a diagram illustrating another example of the notification about the result information of the passability determination. FIG. 14B illustrates an example where the evacuation route is not passable. At this time, the output unit 414 may output a message indicating that the evacuation route is not passable and a mark indicating which of evacuation routes is not passable (X mark shown in FIG. 14B) together with each other. Accordingly, the disaster victims can know that the evacuation route is not passable before evacuation and can specify which position is not passable.

### Modification Example

In a modification example of the above-described embodiment, the processes described in the embodiment may be combined with each other or any of the processes may not be provided. A portion of the processes in the small size vehicle may be performed by the information processing device 200.

What is claimed is:

1. A small size vehicle comprising:
an imaging unit configured to capture an image of a space ahead of the small size vehicle;
a receiver configured to receive an emergency signal;
an acquisition unit configured to acquire pre-set evacuation route information in a case where the emergency signal is received; and
a determination unit configured to determine whether an evacuation route indicated by the evacuation route information is passable for a person or not, based on the image captured by the imaging unit, when the small size vehicle travels along the evacuation route.

2. The small size vehicle according to claim 1, further comprising a driving controller configured to control autonomous travel,
wherein the driving controller performs control such that the small size vehicle autonomously travels along the evacuation route in a case where the emergency signal is received.

3. The small size vehicle according to claim 2, wherein the driving controller performs control such that the small size vehicle autonomously travels to a pre-set point in a case where the small size vehicle reaches an end point of the evacuation route.

4. The small size vehicle according to claim 1, further comprising an output unit configured to output result information indicating whether the evacuation route is passable for a person up to an end point or not.

5. The small size vehicle according to claim 1, wherein the determination unit determines whether an obstacle is present on the evacuation route or not, based on the image captured by the imaging unit and determines whether the evacuation route is passable for a person or not in accordance with presence or absence of the obstacle.

6. The small size vehicle according to claim 1, further comprising:
a removing member configured to remove an obstacle; and
a drive controller configured to control driving of the removing member to move a removable obstacle outside the evacuation route in a case where the determination unit determines that the removable obstacle is present on the evacuation route.

7. The small size vehicle according to claim 6, wherein, in a case where the determination unit determines that an obstacle on the evacuation route is not removable, the determination unit registers a point on which the obstacle is present as a point not passable for a person.
